(19) United States
(12) Patent Application Publication
(10) Pub. No.: US 2010/0212026 A1
(43) Pub. Date: Aug. 19, 2010

(54) IMAGE FORMING APPARATUS, LICENSE MANAGEMENT SYSTEM AND LICENSE MANAGEMENT METHOD

(75) Inventor: Sachiko Yoshimura, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Kyocera Mita Corporation, Osaka (JP)

(21) Appl. No.: 12/575,324

(22) Filed: Oct. 7, 2009

(30) Foreign Application Priority Data
Feb. 13, 2009 (JP) 2009-030952

(51) Int. Cl. G06F 21/22; G06F 9/445; G06F 9/455

(52) U.S. Cl. 726/29; 717/178; 718/1

(57) ABSTRACT

An image forming apparatus comprises a communication interface unit that performs communication with a terminal device, a storage unit that stores an application program installed under license and a management application program for managing the application program, an arithmetic processing unit that executes the application program and the management application program stored in the storage unit, a determination unit that determines whether or not predetermined software installed in the terminal device has a legitimate license code corresponding to the license of the management application program, and an installing unit that, when it is determined that the predetermined software has a legitimate license code, obtains the application program from the terminal device and installs the application program into the storage unit.

### INCORPORATION BY REFERENCE

This application is based upon and claims the benefit of priority from corresponding Japanese Patent Application No. 2009-030952, filed Feb. 13, 2009, the entire contents of which is incorporated herein by reference.

### BACKGROUND

1. Field of the Invention

The present invention relates to an image forming apparatus, a license management system and a license management method.

2. Description of the Related Art

When an application program is installed into an image forming apparatus, such as a multifunction peripheral (MFP), and is to be used, a license is usually necessary. For example, unless a license code and activation is input, a commercial application program is typically not made usable.

For example, in a certain license management system, an application program, a platform, and a key file have been stored in an SD memory card. The application program is installed from an SD memory card into an MFP specified in the key file. When the MFP accesses a predetermined server so as to request activation, and the activation is successful, the application becomes usable.

In the above-mentioned license management system, license management is performed during the activation process in which a server is used. For this reason, only the application program in compliance with the license becomes usable.

However, sometimes an application program has not yet been assigned a license code, such as when an application program is at the development stage (e.g. a beta version). In such a circumstance, installation using activation through a server cannot be performed similarly to installation of a commercial application program.

### SUMMARY

According to an embodiment of the present invention, an image forming apparatus comprises a storage unit configured to store an application program installed under license, and a management application program for managing the application program; an arithmetic processing unit configured to execute the application program and the management application program stored in the storage unit; a determination unit configured to determine whether or not predetermined software installed in a terminal device has a legitimate license code corresponding to the license of the management application program, wherein the terminal device has stored thereon predetermined software installed under license, and wherein the predetermined software has a license code stored as data; and an installing unit configured to, when it is determined by the determination unit that the predetermined software has a legitimate license code, obtain the application program from the terminal device and install the application program into the storage unit.

According to another embodiment of the present invention, a license management method comprises the steps of: reading, in the image forming apparatus, a management application program from a first storage device and executing the management application program; reading, in the terminal device, a program contained in predetermined software from a second storage device for storing a license code as data in the predetermined software installed under license, and executing the program; determining whether or not the predetermined software installed into the terminal device has a legitimate license code corresponding to the license of the management application program; upon determining that the predetermined software has a legitimate license code, making, with the image forming apparatus, a request for an additional application program to the terminal device indicated by the management application program; transmitting, in the terminal device, the additional application program to the image forming apparatus in response to a request for the additional application program from the image forming apparatus indicated by a program contained in the predetermined software; and receiving, in the image forming apparatus, the additional application program and installing the additional application program into the first storage device indicated by the management application program.

Additional features and advantages are described herein, and will be apparent from the following Detailed Description and the figures.

### BRIEF DESCRIPTION OF THE FIGURES

In the accompanying drawings:

FIG. 1 is a block diagram illustrating the configuration of a license management system according to an embodiment of the present invention;

FIG. 2 illustrates an install package of a commercial application program installed into a multifunction peripheral (MFP) in the system illustrated in FIG. 1;

FIG. 3 is a block diagram illustrating the configuration of an MFP in a state in which a commercial application program is installed into an MFP in the system illustrated in FIG. 1 and is executed;

FIG. 4 is a sequence diagram illustrating a process where a development application program is to be installed into an MFP in the system illustrated in FIG. 3;

FIGS. 5A, 5B, 5C, 5D, and 5E illustrate examples of screens displayed on the display operation panel of a multifunction peripheral in the process illustrated in FIG. 4;

FIG. 6 is a block diagram illustrating the configuration of a multifunction peripheral in a state in which a development application program has been installed into the MFP illustrated in FIG. 3;

FIG. 7 is a sequence diagram showing a process where a development application program is to be started in the MFP in the system illustrated in FIG. 6;

FIGS. 8A, 8B, and 8C illustrate examples of screens displayed on the display operation panel of the MFP in the process illustrated in FIG. 7; and

FIG. 9 is a block diagram illustrating the configuration of an MFP in a state in which a development application program has been started in the MFP illustrated in FIG. 6.

### DETAILED DESCRIPTION

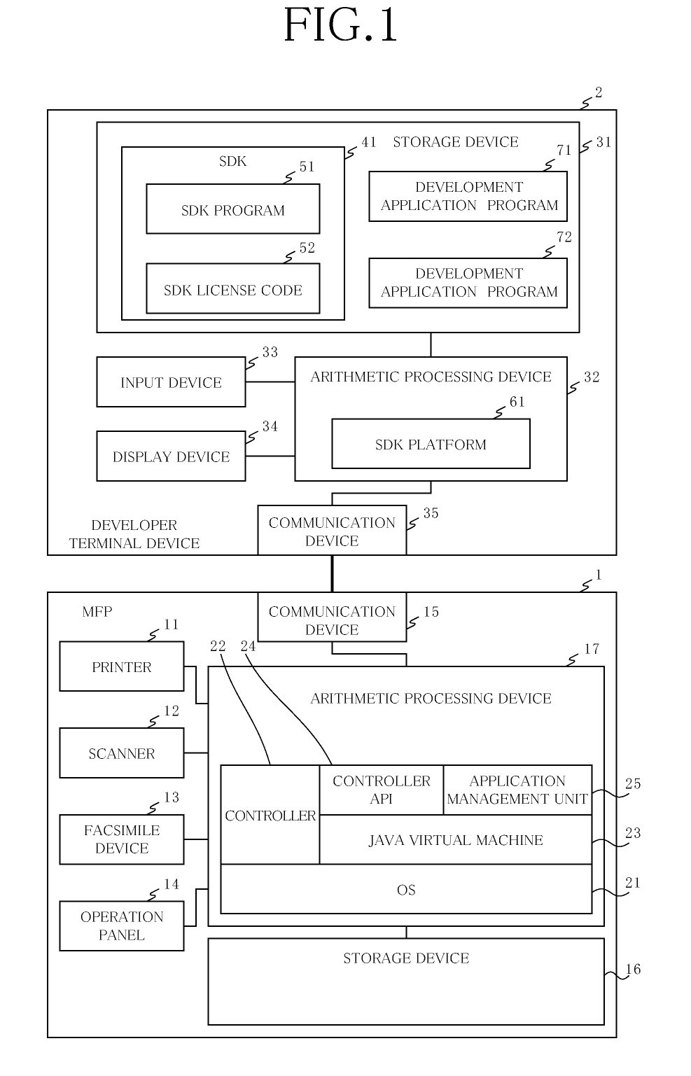

FIG. 1 is a block diagram illustrating the configuration of a license management system according to an embodiment of the present invention. The system illustrated in FIG. 1 includes a multifunction peripheral (MFP) 1 and a developer terminal device 2. Data communication is possible between the MFP 1 and the developer terminal device 2 via a communication path, such as a network. The MFP 1 is one kind of image forming apparatus. The developer terminal device 2 is constituted by, for example, a personal computer.

The MFP 1 includes a printer 11, a scanner 12, a FAX device 13, an operation panel 14, a communication device 15, a storage device 16, and an arithmetic processing device 17.

The printer 11 is a device that prints a document image on the basis of print data. The scanner 12 is a device that optically reads a document image from a document and that creates a document image. The facsimile device 13 is a device that generates a facsimile signal from the document data to be transmitted and transmits the signal, and also receives a facsimile signal and converts it into document data.

The operation panel 14 is arranged on the housing surface of the MFP 1, and has a display device for displaying various kinds of information for a user and an input device for detecting user operation. As the display device (an example of a display unit), for example, a liquid-crystal display panel is used. As an input device (an example of an input unit), a key switch, a touch panel, and the like are used.

The communication device 15 (an example of a communication interface unit) is a device that is connected to a communication path so as to be capable of performing data communication with the developer terminal device 2. When the MFP 1 and the developer terminal device 2 are connected to the same computer network, a network interface is used for the communication device 15. When the MFP 1 and the developer terminal device 2 are connected to the same telephone network, a modem is used for the communication device 15.

The storage device 16 (an example of a storage unit or a first storage device) is a device that is capable of storing various kinds of programs and various kinds of data. For the storage device 16, a hard disk drive, a non-volatile memory, or the like is used.

The arithmetic processing device 17 is a computer having a central processing unit (CPU), a read-only memory (ROM), a random access memory (RAM), and the like. The arithmetic processing device 17 loads a program from the storage device 16 or the like into a RAM, and causes the CPU to execute the program, thereby realizing various kinds of processors, such as an arithmetic processing unit, a determination unit, and an installing unit.

The storage device 16 stores at least a program having the minimum requirements for the operation of the MFP 1. Then, after the MFP 1 is started, the program is executed as appropriate by the arithmetic processing device 17. This program allows for the implementation of an operating system (OS) 21, a controller 22, a JAVA virtual machine 23, a controller Application Program Interface (API) 24, and an application management unit 25.

The controller 22 controls the printer 11, the scanner 12, the facsimile device 13, and the operation panel 14, and performs data input/output to and from them.

When the controller API 24 causes the functions of the printer 11, the scanner 12, the facsimile device 13, and the operation panel 14 to be performed, or causes data input/output to be performed to and from them, the controller API 24 causes the controller 22 to be operated by an instruction from an application program that operates in the JAVA virtual machine 23.

The application management unit 25 manages the life cycle (installing, start-up, stopping, and uninstalling) of a commercial application program. That is, the application management unit 25 performs installing, starting, stopping, and uninstalling of a commercial application. The details of the installing of the commercial application will be described later.

The developer terminal device 2 includes a storage device 31, an arithmetic processing device 32, an input device 33, a display device 34, and a communication device 35.

The storage device 31 (an example of a second storage device) is a device that is capable of storing various kinds of programs and various kinds of data. For the storage device 31, a hard disk drive, a non-volatile memory, or the like is used. A software development kit 51 is stored in the storage device 31.

The software development kit (SDK) 41 is software having an SDK program 51 and an SDK license code 52. The SDK program 51 is a program for providing the development environment of an application program that can be executed by the MFP 1. The SDK license code 52 is data that is attached after license authentication is successful at the time the SDK 41 is to be installed. The SDK license code 52 is used as license identification data specific to the SDK 41 having a legitimate license.

The SDK 41 forms a pair with an SDK management application program (to be described later), and is subjected to license management. Therefore, common information, such as a common serial number and a common identifier, is attached to the SDK 41 and the SDK management application program, which form a pair. Then, the SDK license code 52 is generated on the basis of the common information.

The arithmetic processing device 32 is a computer having a CPU, a ROM, a RAM, and the like. The arithmetic processing device 32 loads a program from the storage device 31 or the like into the RAM and causes the program to be executed by the CPU, thereby realizing various kinds of processors, such as a second arithmetic processing unit and a transmission unit.

After the developer terminal device 2 is started, when the SDK program 51 is executed by the arithmetic processing device 32, an SDK platform 61 is realized. The SDK platform 61 operates on the OS, and provides a program development environment having an editor, a compiler, a library, a debugger, a simulator, and the like. Application programs (development application programs) 71 and 72, which have been developed or are being developed by the SDK platform 61, are stored in the storage device 31.

The input device 33 is a device that detects user operation. For the input device 33, a keyboard, a mouse, and the like are used. The display device 34 is a device that displays various kinds of information to the user. For the display device 34, for example, a liquid-crystal display panel is used.

The communication device 35 is a device that is connected over a communication path and that is capable of performing data communication with the MFP 1. When the MFP 1 and the developer terminal device 2 are connected to the same computer network, a network interface is used for the communication device 35. In a case where the MFP 1 and the developer terminal device 2 are connected to the same telephone network, a modem is used for the communication device 35.

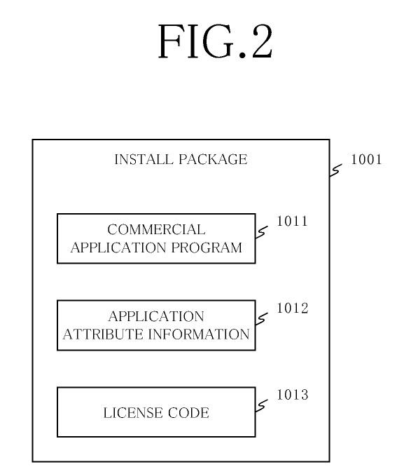

A description will be given of a case of installing a commercial application into the MFP 1 in FIG. 1. FIG. 2 shows a package in which a commercial application to be installed into the MFP 1 in the system illustrated in FIG. 1 is installed.

An install package 1001 is a data file having a commercial application program 1011, application attribute information 1012, and a license code 1013. An authorized install package 1001 is created by an authorized issuer and has authorized application attribute information 1012 and the license code 1013.

The application attribute information 1012 is information necessary for starting the commercial application program 1011. For example, the application attribute information 1012 includes vendor information, version information, the URL of a Web page displayed at first after the commercial application program is started, and the like.

The license code 1013 is data for use in a process for authenticating the license of the commercial application program 1011. The license code 1013 is used to determine whether or not the license code input by a user at the time of installing is correct. The license code 1013 is transmitted together with an activation request to an activation server.

After the install package 1001 is stored on a recording medium or stored in the MFP 1 from a communication medium, the application management unit 25 performs a license authentication process by using the application attribute information 1012 and the license code 1013.

The license authentication process may include, for example, performing the following steps.

(a) An input image is displayed on an operation panel so as to prompt the user to input a license code. On the basis of whether or not the license code input by the user matches the license code 1013, a determination is made as to the presence or absence of the license.
(b) The license code 1013 is transmitted together with an activation request for the activation server. A response containing permission/nonpermission of the activation is received from the server. On the basis of the response, a determination is made as to the presence or absence of the license.

The license code 1013 may not be contained in the install package 1001, and may be printed in the manual of the commercial application program 1011, so that the user is made to input the license code. In that case, the input license code is transmitted together with the activation request for the activation server. A response containing the permission/nonpermission of the activation is received from the server. On the basis of the response, a determination is made as to the presence or absence of the license.

When the user has a license in the license authentication process, the application management unit 25 reads the commercial application program 1011, the application attribute information 1012, and the license code 1013 from the install package 1001, and stores them in the storage device 16.

Only a commercial application program having an authorized license is installed into the MFP 1.

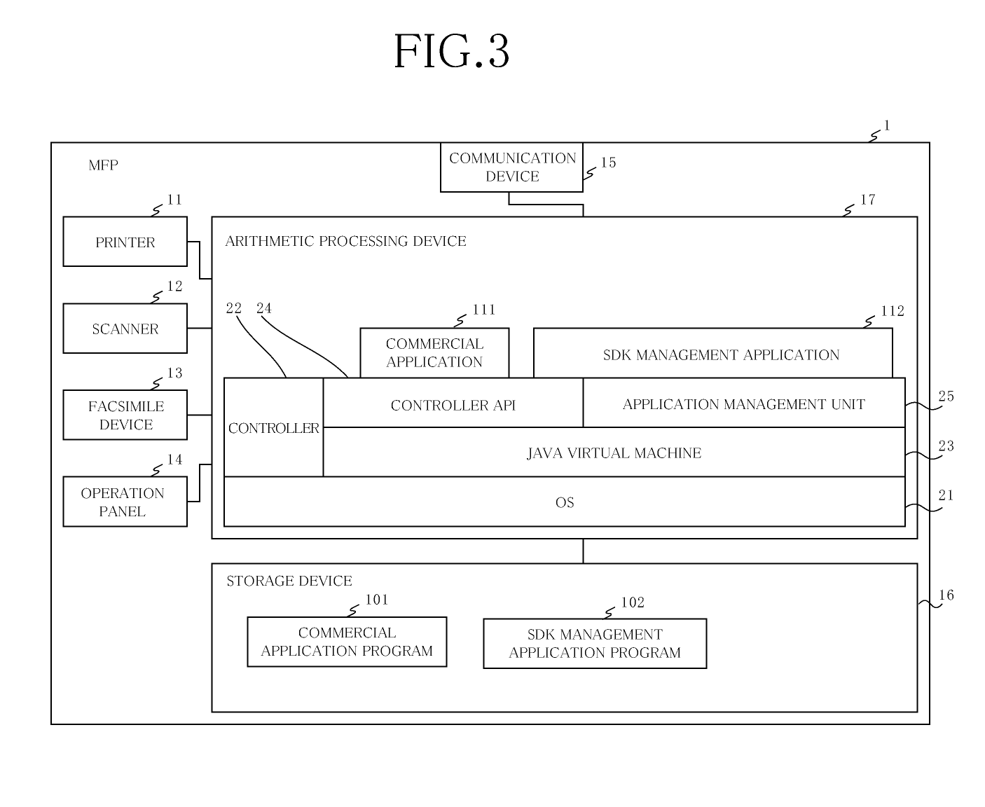

FIG. 3 is a block diagram illustrating the configuration of the MFP 1 in a state in which the commercial application program is installed into the MFP 1 in the system illustrated in FIG. 1 and executed. In the configuration illustrated in FIG. 3, as commercial application programs, the commercial application program 101 and the SDK management application program 102 have been installed.

The license code 1013 of the SDK management application program 102 is generated on the basis of the common information with the above-mentioned SDK 41 which forms a pair. Therefore, on the basis of one of the license codes, the other license code which forms a pair can be identified. For example, the license codes of the SDK 41 and the SDK management application program 102, which form a pair, may be set to the same value.

The commercial application 111 is executed when the commercial application program 101 is executed on the JAVA virtual machine 23. The SDK management application 112 is executed when the SDK management application program 102 is executed on the JAVA virtual machine 23.

It is possible for the SDK management application 112 to install the additional application programs (the development application programs 71 and 72) developed by a specific SDK platform 61 corresponding to the SDK management application 112 without license authentication regarding the additional application programs.

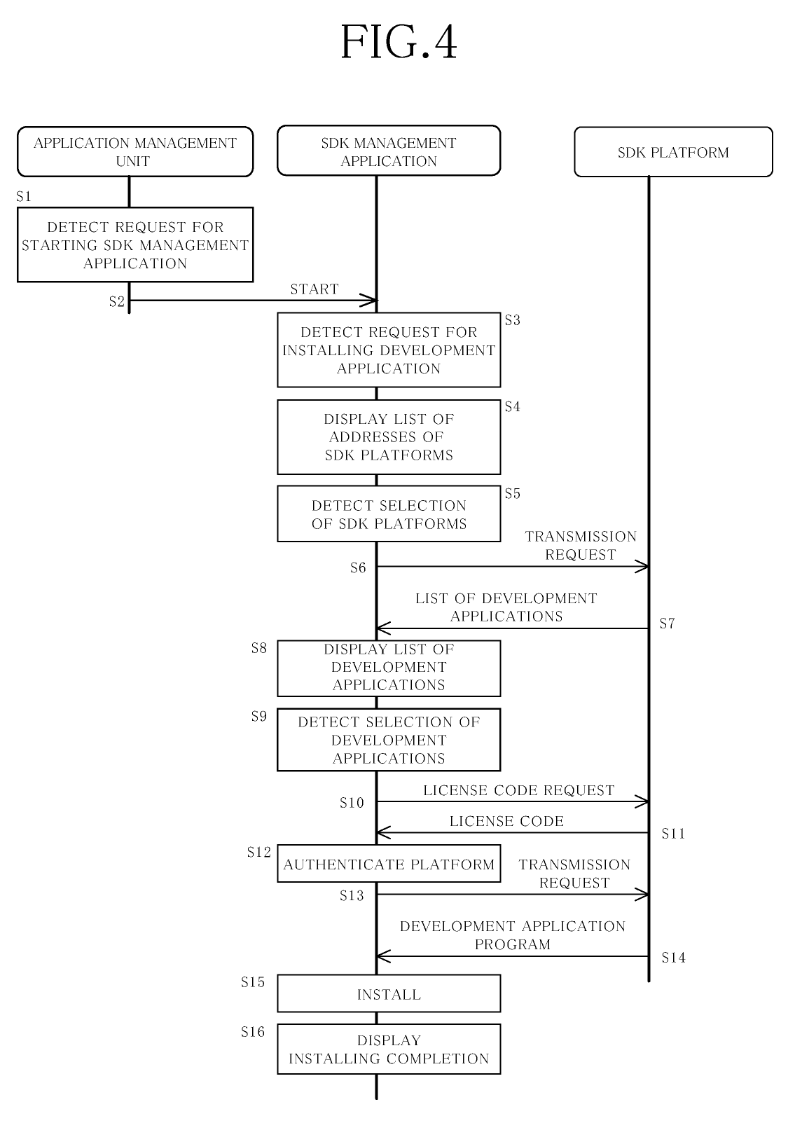

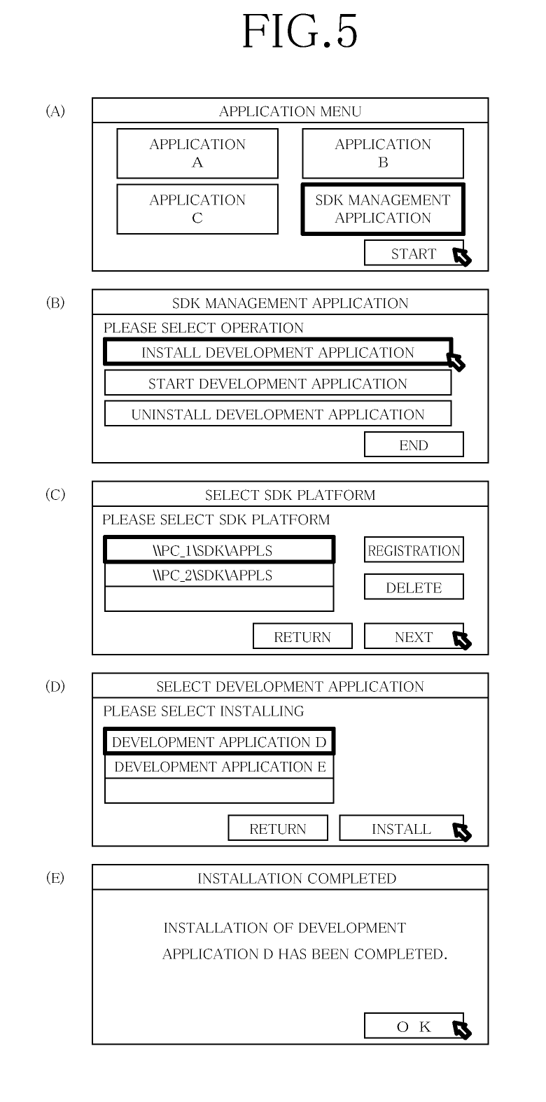

FIG. 4 is a sequence diagram illustrating an example process that can be used when a development application program is to be installed into the MFP 1 in the system illustrated in FIG. 3. FIGS. 5A to 5E illustrate examples of screens displayed on the operation panel 14 of the MFP 1 for the process illustrated in FIG. 4.

The application management unit 25 of the MFP 1 causes the display device of the operation panel 14 to display, as illustrated in FIG. 5A, an application menu for selecting installed commercial application programs. Then, in this menu, “SDK Management Application” is selected, and a “Start” button is pressed. These user operations are detected by the input device of the operation panel 14 and are notified to the application management unit 25 (step S1). Upon receiving the notification, the application management unit 25 calls the SDK management application program 102 and starts the SDK management application 112 (step S2).

When the SDK management application 112 is started, it causes the display device of the operation panel 14 to display an operation menu, as illustrated in, for example, FIG. 5B. Then, in this menu, “install development application” is selected. The user operation is detected by the input device of the operation panel 14 and is notified to the SDK management application 112 (step S3). Upon receiving the notification, the SDK management application 112 causes the display device of the operation panel 14 to display a selection screen containing an address list of the SDK platforms, as illustrated in, for example, FIG. 5C. The SDK management application 112 reads and displays the address of the SDK platform registered in the prestored set data (step S4). When a “Registration” button is pressed on the selection screen of the address illustrated in FIG. 5C, an input screen for inputting a new address is displayed. Then, when a new address is input on the input screen, the address is registered in the set data. When a “Delete” button is pressed on the selection screen, the selected address is deleted from the set data.

In this list, the address of the SDK platform 61 of the developer terminal device 2 is selected, and a “Next” button is pressed. These user operations are detected by the input device of the operation panel 14, and are notified to the SDK management application 112 (step S5). Upon receiving the notification, the SDK management application 112 transmits, by using the communication device 15, a request for transmitting a list of the development application programs 71 and 72 (which are developed by the SDK platform 61 and stored in the storage device 31) to the SDK platform 61 at the selected address (step S6).

When the SDK platform 61 of the developer terminal device 2 receives the transmission request by using the communication device 35, the SDK platform 61 transmits to the MFP 1 the list of the development application programs 71 and 72 that are developed by the SDK platform 61 and are stored in the storage device 31. The SDK platform 61 performs this transmission using the communication device 35 (step S7).

When the SDK management application 112 of the MFP 1 receives the list by using the communication device 15, the SDK management application 112 causes the display device of the operation panel 14 to display a selection screen containing the list, as illustrated in, for example, FIG. 5D (step S8). When one of the development application programs is selected in this list, and the “Install” button is pressed, these user operations are detected by the input device of the operation panel 14 and are notified to the SDK management application 112 (step S9). Upon receiving the notification, the SDK management application 112 transmits a request for transmitting a license code to the SDK platform 61 selected in step S5 by using the communication device 15 (step S10).

When the transmission request is received by the communication device 35, the SDK platform 61 of the developer terminal device 2 reads a license code 52 and transmits it to the MFP 1 by using the communication device 35 (step S11).

When the license code 52 is received by using the communication device 15, the SDK management application 112 of the MFP 1 performs an authentication process with regard to the SDK platform 61 on the basis of the license code 52 (step S12).

In the authentication process, it is determined whether or not the license code 52 corresponds to the license code of the SDK management application 112. For example, depending on whether or not they match or whether or not a predetermined function value for one of them matches the other value, it is determined whether or not the license code 52 corresponds to the license code of the SDK management application 112. When the license code 52 corresponds to the license code of the SDK management application 112, downloading of the development application programs 71 and 72 from the SDK platform 61 having the license code 52 is permitted. If the license code 52 does not correspond, the downloading of the development application programs 71 and 72 from the SDK platform 61 is not permitted.

This authentication process may be performed in the following manner. The SDK management application 112 transmits the license code 52, the license code of the SDK management application 112, and the authentication request to the server. Then, an authentication result indicating whether or not the downloading of the development application programs 71 and 72 from the SDK platform 61 having the license code 52 has been permitted is received from the server.

When the downloading of the development application program from the SDK platform 61 has been permitted, the SDK management application 112 transmits a request for transmitting the development application program selected in step S9 to the SDK platform 61 by using the communication device 15 (step S13).

When the SDK platform 61 of the developer terminal device 2 receives the transmission request by using the communication device 35, the SDK platform 61 reads the development application program specified in the transmission request. Then, the communication device 35 transmits the development application program together with the attribute information on the development application program to the MFP 1 (step S14). This attribute information contains the name of the development application program and the like.

When the SDK management application 112 of the MFP 1 receives the development application program and the attribute information by using the communication device 15, the SDK management application 112 stores the development application program in a predetermined storage area in the recording device 16. On the basis of the attribute information on the development application program, the SDK management application 112 registers the development application program in the additional application list (step S15). The additional application list, which is stored in the storage device 16, contains attribute information, such as the name of each development application program and the place where the additional application list is stored.

When installation of the development application program has been completed in the manner described above, the SDK management application 112 causes the display device of the operation panel 14 to display a screen containing a message of the completed installation, as illustrated in, for example, FIG. 5E (step S16). Thereafter, when an OK button on the screen is pressed, the user operation is detected by the input device of the operation panel 14 and is notified to the SDK management application 112. Upon receiving the notification, the SDK management application 112 causes an operation menu screen to be displayed again, as illustrated in, for example, FIG. 5B.

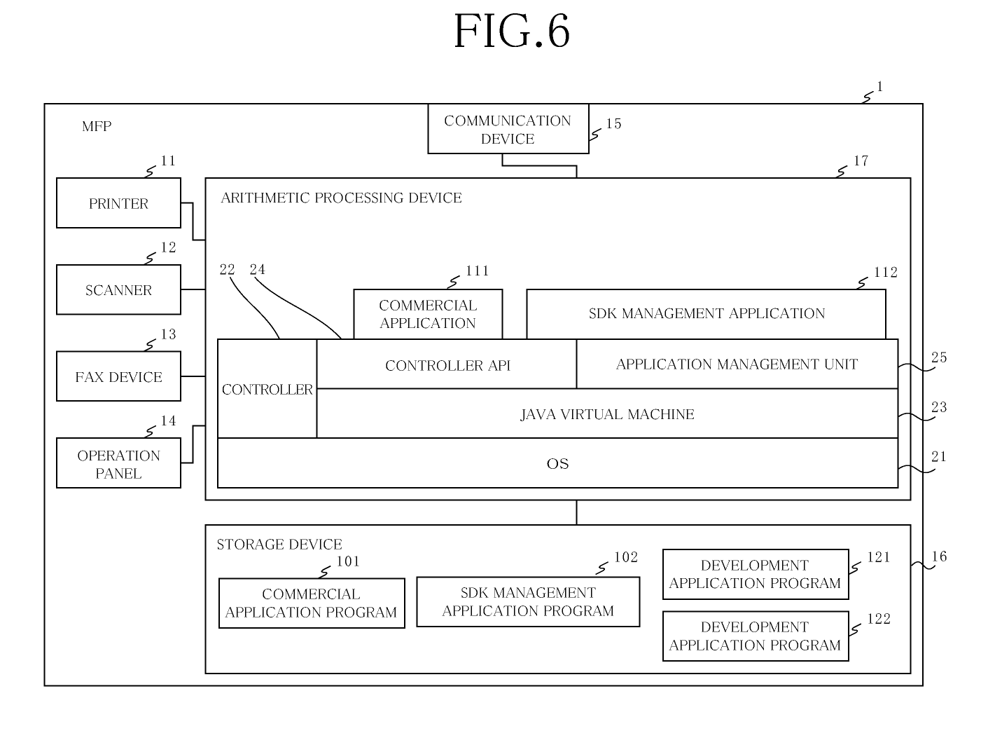

In the manner described above, installation of the development application program into the MFP 1 is performed. FIG. 6 is a block diagram illustrating the configuration of the MFP 1 when a development application program has been installed into the MFP illustrated in FIG. 3. In the configuration illustrated in FIG. 6, two development application programs 121 and 122 have been installed into the MFP 1.

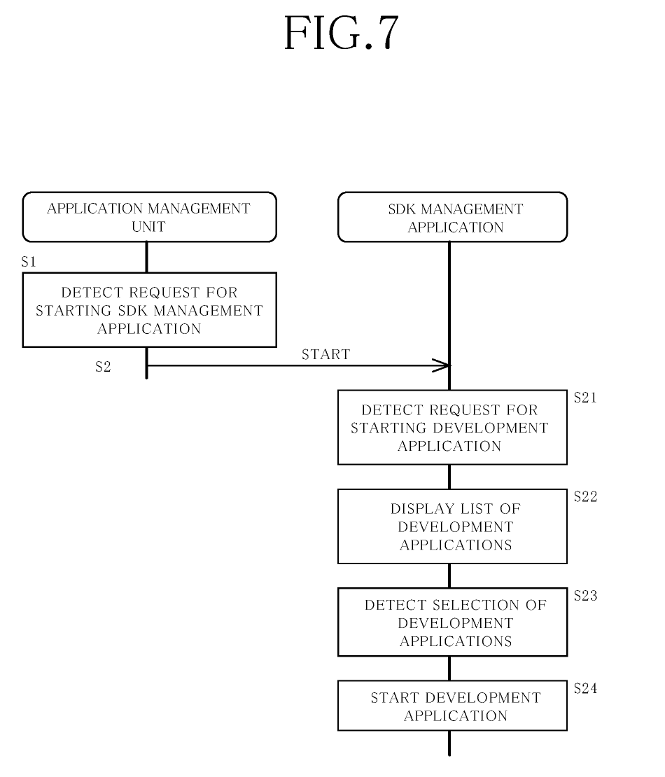

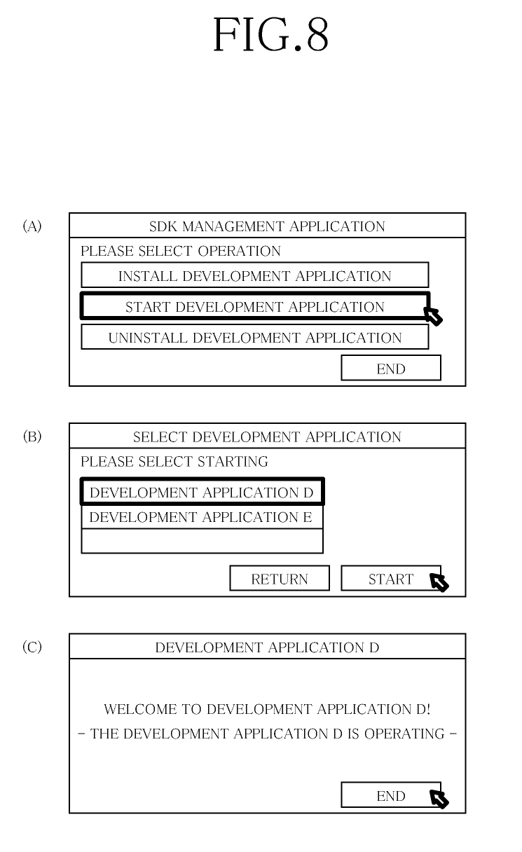

Next, a description will be given of the starting of a development application installed into the MFP 1. FIG. 7 is a sequence diagram illustrating a process undertaken when a development application program is to be started in the MFP 1 in the system illustrated in FIG. 6. FIGS. 8A to 8C illustrate examples of screens displayed on the display operation panel of the MFP 1 in the process illustrated in FIG. 7.

In the MFP 1, when the application management unit 25 starts the SDK management application 112 (steps S1 and S2), the SDK management application 112 causes the display device of the operation panel 14 to display an operation menu, as illustrated in, for example, FIG. 8A. Then, in this menu, when “start development application” is selected, the user operation is detected by the input device of the operation panel 14 and is notified to the SDK management application 112 (step S21). Upon receiving the notification, the SDK management application 112 identifies the installed additional application programs (the above-mentioned development application programs 121 and 122) by referring to the above-mentioned additional application list. The SDK management application 112 causes the display device of the operation panel 14 to display the list of the installed additional application programs, as illustrated in, for example, FIG. 8B (step S22).

In this list, when one of the development application programs is selected and the Start button is pressed, these user operations are detected by the input device of the operation panel 14 and are notified to the SDK management application 112 (step S23). Upon receiving the notification, the SDK management application 112 identifies the selected development application program. On the basis of the attribute information of the development application program, the SDK management application 112 calls the development application program and starts the development application (step S24). After the development application is started, the display device of the operation panel 14 displays the screen of the development application illustrated in, for example, FIG. 8C. The development application program is executed on the JAVA virtual machine 23.

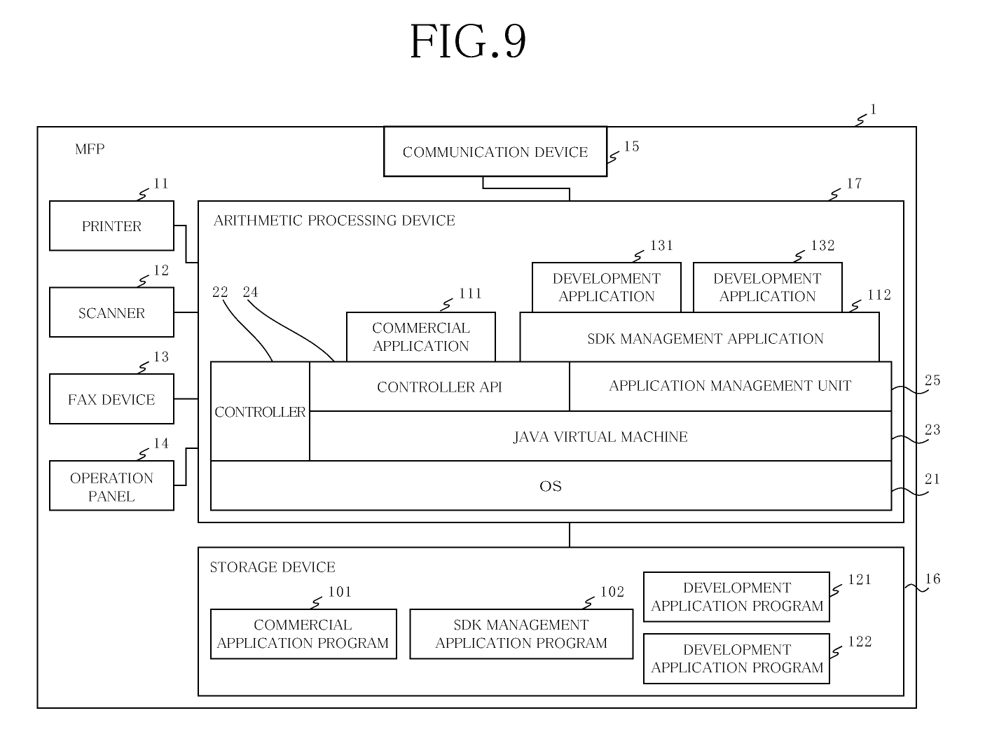

In the manner described above, the development application installed into the MFP 1 is started by the SDK management application 112. FIG. 9 is a block diagram illustrating the configuration of the MFP 1 in a state in which the development application programs 121 and 122 have been started in the MFP 1 illustrated in FIG. 6. In the configuration illustrated in FIG. 9, development applications 131 and 132 using the two development application programs 121 and 122 are operated.

As described above, according to the above-described first embodiment, the MFP 1 includes the storage device 16 capable of storing application programs installed under license and the arithmetic processing device 17 that executes an application program stored in the storage device 16. The storage device 16 stores the SDK management application program 102 as one of the application programs. Furthermore, the arithmetic processing device 17 executes the SDK management application program 102 and determines whether or not the SDK 41 has a legitimate license code corresponding to the license of the SDK management application program 102. When the SDK 41 has a legitimate license code, a request for a development application program is made, as indicated by the management application program 102, and the development application program is obtained from the SDK platform 61 by using the SDK 41. It is then installed into the storage device 16.

On the other hand, the terminal device 2 includes a storage device 31 into which the SDK 41 is installed under license and a license code 52 is stored as data in the SDK 41. The arithmetic processing device 32 executes the SDK program 51 contained in the SDK 41 and transmits a development application program to the MFP 1 in response to a request for the development application program from the MFP 1. That is, only in the state in which the SDK platform 61 is started, is the development application program transmitted to the MFP 1.

As a result of the SDK management application 112 being installed into the MFP 1 within the range of the license of the SDK management application 112, it is possible to obtain and install a development application program from only the SDK platform 61 of a specific SDK 41 having the license code 52. As a result, it is possible to obtain and install a development application program even in the MFP 1 in which a commercial application program can be installed only under license.

Therefore, it is possible to effectively perform license management for the SDK 41. Furthermore, since a development application can be started from only the SDK management application 112, even if the development application program is illegally distributed, the development application program is not executed in an MFP that has no SDK management application.

It is possible to cause a development application program to be operated in the MFP 1 in a test manner.

A license management system according to a second embodiment of the present invention provides development application programs 71 and 72 of one SDK 41 to only a predetermined number (one or more) of MFPs 1. One MFP 1 can obtain an additional application program from only a predetermined number (one or more) of SDKs 41 (that is, the terminal device 2 in which a predetermined number of SDKs 41 have been installed).

For example, in the MFP 1, the SDK management application 112 registers identification information (that which can be obtained by the MFP 1 from the terminal device 2, such as the network address and the product serial number) of the terminal device 2 (or the SDK platform 61), which is the downloading source of the development application program. The SDK management application 112 then downloads a development application program from only the SDK platform 61 of a predetermined number of terminal devices 2.

For example, in the terminal device 2, the SDK platform 61 registers the identification information (that which can be obtained by the terminal device 2 from the MFP 1, such as the network address and the product serial number) of the MFP 1 that has transmitted the development application program, and supplies the development application program to only a predetermined number of MFPs 1.

According to the above-described second embodiment, it is possible to limit the number of image forming apparatuses that can install an additional application program from predetermined software and the number of predetermined software programs (terminal devices) that are capable of providing an additional application program to an image forming apparatus.

Although the above-described embodiments are preferred examples of the present invention, the present invention is not limited to these embodiments, and various modifications and changes can be made without departing from the spirit and scope of the present invention.

For example, an application program might not be stored in the storage device 16 in the MFP 1 and instead may be stored in the storage device 16 in another device with which communication is possible. In the storage device 16, information (the file path, the URL, etc.) indicating the place of another device where the application program is stored, may be stored. In that case, on the basis of the information, the arithmetic processing device 17 identifies the place where the application program is stored and obtains the application program from the other device.

In the above-described embodiments the MFP 1 is used as the image forming apparatus instead; however, a copier, a facsimile machine, or the like alternatively may be used.

In the above-described embodiments, the number of development application programs that can be installed into one MFP 1 may be limited to smaller than or equal to a predetermined number.

In the above-described embodiments, a portable recording medium (a USB memory, a memory card, etc.) may be used for data communication between the MFP 1 and the terminal device 2. In that case, in place of the communication devices 15 and 35, reader/writers for the recording medium are used.

In the above-described embodiments, a development application program may be downloaded from, in place of the terminal device 2, a server that stores and manages development application programs developed by the SDK platform of the client device to the MFP 1.

In the above-described embodiments, the SDK management application program 102 and the development application program are JAVA programs that operate in the JAVA virtual machine 23.

What is claimed is:

1. An image forming apparatus comprising:
a storage unit configured to store an application program installed under license and a management application program for managing the application program;
a arithmetic processing unit configured to execute the application program and the management application program stored in the storage unit;
a determination unit configured to determine whether or not predetermined software installed in a terminal device has a legitimate license code corresponding to the license of the management application program, wherein the terminal device has stored thereon predetermined software installed under license, and wherein the predetermined software has a license code stored as data; and
an installing unit configured to, when it is determined by the determination unit that the predetermined software has a legitimate license code, obtain the application program from the terminal device and install the application program into the storage unit.

2. The image forming apparatus according to claim 1, wherein the predetermined software is a software development kit for providing a program development environment, and wherein the application program is an application program developed using the software development kit.

3. The image forming apparatus according to claim 1, wherein the license code is obtained when the predetermined software undergoes license authentication, is installed into the terminal device.

4. The image forming apparatus according to claim 1, wherein the terminal device provides an additional application program from a predetermined software program to only a predetermined number of image forming apparatuses.

5. The image forming apparatus according to claim 1, wherein the image forming apparatus obtains an additional application program from only a predetermined number of predetermined software programs.

6. The image forming apparatus according to claim 1, wherein the terminal device transmits a list of application programs to the image forming apparatus in response to a request from the image forming apparatus.

7. The image forming apparatus according to claim 6, wherein the request is made by the installing unit, and wherein the management application program indicates the terminal device to which the request is transmitted.

8. The image forming apparatus according to claim 6, wherein the installing unit requests from the terminal device the application program selected from the list.

9. The image forming apparatus according to claim 1, wherein the application program is called from the management application program and is executed by the arithmetic processing unit.

10. The image forming apparatus according to claim 1, wherein the image forming apparatus further comprises:
a display unit configured to display a list of application programs stored in the storage unit; and
an input unit configured to accept a selection of the application program from the list of the application programs.

11. The image forming apparatus according to claim 10, wherein the display unit displays a list of the application programs installed into the storage device.

12. The image forming apparatus according to claim 1, wherein the first arithmetic processing unit operates as a JAVA virtual machine, and
wherein the management application program and the application program are JAVA programs that operate in the JAVA virtual machine.

13. A license management system comprising:
an image forming apparatus; and
a terminal device;
the image forming apparatus comprising:
a first storage unit configured to store an application program installed under license and a management application program for managing the application program;
a first arithmetic processing unit configured to execute the application program and the management application program stored in the first storage unit;
a determination unit configured to determine whether or not predetermined software installed in the terminal device has a legitimate license code corresponding to the license of the management application program, and
an installing unit configured to, when it is determined by the determination unit that the predetermined software has a legitimate license code, obtain the application program from the terminal device and install the application program into the first storage unit;
the terminal device comprising:
a second storage unit configured to store predetermined software installed under license and a license code as data in the predetermined software,
a second arithmetic processing unit configured to execute a program contained in the predetermined software, and
a transmission unit configured to transmit, indicated by the program executed by the second arithmetic processing unit, the application program to the image forming apparatus in response to a request for the application program from the image forming apparatus.

14. The license management system according to claim 13, wherein the application program is called from only the management application program and is executed by the first arithmetic processing unit.

15. The license management system according to claim 13, wherein the first arithmetic processing unit operates as a JAVA virtual machine, and
wherein the management application program and the application program are JAVA programs that operate in the JAVA virtual machine.

16. A license management method for installing an additional application program from a terminal device to an image forming apparatus, the license management method comprising the steps of:
reading, with the image forming apparatus, a management application program from a first storage device and executing the management application program;
reading, with the terminal device, a program contained in predetermined software from a second storage device and executing the program, wherein the program is for storing a license code as data in predetermined software installed under license;
determining whether or not the predetermined software installed into the terminal device has a legitimate license code corresponding to the license of the management application program;
upon determining that the predetermined software has a legitimate license code, making, with the image forming apparatus, a request for an additional application program to the terminal device indicated by the management application program;
transmitting, with the terminal device, the additional application program to the image forming apparatus in response to a request for the additional application program from the image forming apparatus indicated by a program contained in the predetermined software; and
receiving, with the image forming apparatus, the additional application program and installing the additional application program into the first storage device indicated by the management application program.

17. The license management method according to claim 16, further comprising displaying, with the image forming apparatus, a list of the application programs installed into the first storage device

18. The license management method according to claim 16, wherein the management application program and the additional application program are JAVA programs that operate in a JAVA virtual machine on the image forming device.
